(19) United States
(12) Patent Application Publication
(10) Pub. No.: US 2022/0050619 A1
(43) Pub. Date: Feb. 17, 2022

(54) ACCESS COUNTING DEVICE, MEMORY CONTROLLER, AND MEMORY SYSTEM

(71) Applicant: SONY SEMICONDUCTOR SOLUTIONS CORPORATION, KANAGAWA (JP)

(72) Inventors: KENICHI NAKANISHI, TOKYO (JP); KEN ISHII, KANAGAWA (JP)

(21) Appl. No.: 17/309,867

(22) PCT Filed: Oct. 15, 2019
(86) PCT No.: PCT/JP2019/040424

§ 371 Date: Jun. 24, 2021

(30) Foreign Application Priority Data
Jan. 9, 2019 (JP) 2019-001508

(51) Int. Cl. G06F 3/06; G06F 12/10

(52) U.S. Cl. CPC G06F 3/0653; G06F 3/0616; G06F 12/10; G06F 3/0679; G06F 3/0652; G06F 3/0659

(57) ABSTRACT

To suppress influence of access patterns in counting the number of accesses in page units while reducing required buffer capacity. An access history holding section holds an access history for each of first storage units of a memory. An access counter counts the number of accesses of each second storage unit corresponding to a set of a plurality of the first storage units of the memory. The access counter is provided for each second storage unit. A control section updates the access history in the access history holding section in response to an access to the first storage unit of the memory. Further, the control section increments the number of accesses of the second storage unit in the access counter depending on a state of the access history.

### TECHNICAL FIELD

The present technology relates to an access counting device. More specifically, the present technology relates to an access counting device that counts the number of accesses to a memory, a memory controller, and a memory system.

### BACKGROUND ART

Some non-volatile memories have as a characteristic an upper limit on the number of accesses to a memory cell since repeatedly rewriting data in the memory cell causes deterioration and degrades a holding characteristic. Thus, a method of managing a lifespan of a memory cell by counting the number of erasures in block units in a flash memory has been proposed (see, for example, Patent Document 1). This stems from the necessity of an erasure process in block units in rewriting data in a flash memory although a write is performed in page units.

### CITATION LIST

### Patent Document

### Patent Document 1: Japanese Patent Application Laid-Open No. 2004-326523

### SUMMARY OF THE INVENTION

### Problems to be Solved by the Invention

Meanwhile, in next-generation non-volatile memories such as a PCM and a ReRAM, directly rewriting data in page units is possible, and thus counting the number of accesses in page units is required. Since a page size of the next-generation non-volatile memory is small, counting the number of accesses in group units having a plurality of pages can lead to a reduction of required buffer capacity. However, a result of the counting represents the sum of the number of accesses to each page, and does not reflect variation between the respective numbers of accesses to the pages. Performing a refresh process or a wear leveling process at an early timing on the basis of the number of accesses counted in this way causes an increase in the number of writes and may further hinder an access from a host. Furthermore, in a case where counting is performed in group units, the process is conducted without distinguishing between a case where writes are concentrated on a certain page and a case where writes are performed on all the pages on average, resulting in conducting the refresh process and the wear leveling process more frequently.

The present technology has been developed in view of such a situation, and an object thereof is to suppress influence of access patterns in counting the number of accesses in page units while reducing the required buffer capacity.

### Solutions to Problems

The present technology has been made to solve the problems described above. A first aspect of the present technology is an access counting device, a memory controller, and a memory system, including an access history holding section that holds an access history for each of first storage units of a memory, an access counter provided for each of second storage units corresponding to a set of a plurality of the first storage units, the access counter being configured to count the number of accesses, and a control section configured to update the access history in the access history holding section in response to an access to the first storage unit of the memory and to increment the number of accesses of the second storage unit in the access counter depending on a state of the access history. This results in a behavior where the access counter provided for each of the second storage units of the memory counts the number of accesses depending on the state of the access history for each of the first storage units of the memory.

Further, in this first aspect, the access history holding section may hold as the access history a flag of one bit indicating either a first value indicating access history presence or a second value indicating access history absence for each of the first storage units. This results in a behavior where the access history is managed using the 1-bit flag for each of the first storage units.

Further, in this first aspect, the control section may be configured to, when an access to the first storage unit of the memory has occurred, in a case where the flag for the first storage unit to which that access has occurred indicates the first value, update the flag for another first storage unit in the second storage unit to which the access has occurred to the second value and increment the number of accesses of the second storage unit in the access counter, and, in a case where the flag for the first storage unit to which the access has occurred indicates the second value, update the flag for the first storage unit to which the access has occurred to the first value. This results in a behavior where the number of accesses is counted depending on the access history presence/absence for each of the first storage unit of the memory.

Further, in this first aspect, the access history holding section may hold the access history for each of the first storage units using a physical address of the memory, and the access counter may be configured to count the number of accesses for each of the second storage units using the physical address of the memory. This results in a behavior where the access history is managed using the physical address, and the number of accesses is counted using the physical address.

Further, in this first aspect, an address translation section configured to translate a logical address to the physical address of the memory when an access destination with respect to the memory is specified by that logical address may further be included, in which the access history holding section may hold the access history for each of the first storage units using the logical address of the memory, and the access counter may be configured to count the number of accesses for each of the second storage units using the physical address of the memory. This results in a behavior where the access history is managed using the logical address, and the number of accesses is counted using the physical address.

Further, in this first aspect, the access history holding section may hold the access history for each of the first storage units for at least one of the second storage units of the memory, and in a case where an access to the second storage unit that is not held in the access history holding section has occurred, the control section may newly hold the access history for each of the first storage units for that second storage unit. This results in a behavior where the access histories for the second storage unit accessed frequently are held. In this case, the control section may be configured to, in a case where there is no free area for newly holding the access history for each of the first storage units for the second storage unit, delete the access histories for the second storage unit already held in accordance with a predetermined rule and increment the number of accesses of the deleted second storage unit in the access counter by less than usual.

Further, in this first aspect, the access counter may be configured to count the number of writes as the number of accesses, or to count both the number of writes and the number of reads as the number of accesses.

### BRIEF DESCRIPTION OF DRAWINGS

FIG. 1 is a diagram showing a configuration example of an information processing system according to embodiments of the present technology.

FIG. 2 is a diagram showing a configuration example of a memory controller 200 according to a first embodiment of the present technology.

FIG. 3 is a diagram showing a relationship example between a logical address space and a physical address space according to the embodiments of the present technology.

FIG. 4 is a diagram showing an example of an access flag table 230 according to the first embodiment of the present technology.

FIG. 5 is a diagram showing an example of an access count information table 250 according to the embodiments of the present technology.

FIG. 6 is a flow chart showing a processing procedure example of an access counting process according to the first embodiment of the present technology.

FIG. 7 is a flow chart showing a first specific example of the access counting process according to the first embodiment of the present technology.

FIG. 8 is a flow chart showing a second specific example of the access counting process according to the first embodiment of the present technology.

FIG. 9 is a diagram showing a configuration example of a memory controller 200 according to a second embodiment of the present technology.

FIG. 10 is a diagram showing an example of an access flag table cache 235 according to the second embodiment of the present technology.

FIG. 11 is a flow chart showing a specific example of an access counting process according to the second embodiment of the present technology.

### MODE FOR CARRYING OUT THE INVENTION

Hereinafter, modes for carrying out the present technology (hereinafter, referred to as embodiments) will be described. The description will be given in the following order.

1. First Embodiment (Example Using Access Flag Table)

2. Second Embodiment (Example Using Access Flag Table Cache)

### 1. First Embodiment

### [Information Processing System Configuration]

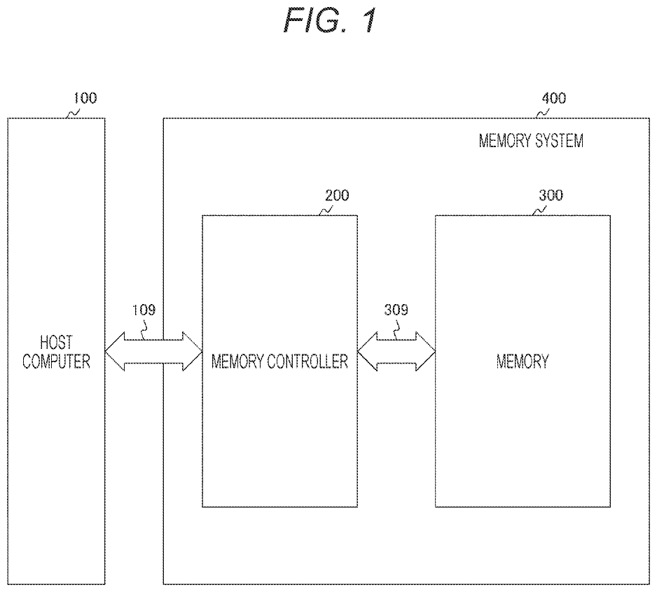

FIG. 1 is a diagram showing a configuration example of an information processing system according to the embodiments of the present technology. This information processing system includes a host computer 100, a memory controller 200, and a memory 300. The memory controller 200 and the memory 300 constitute a memory system 400.

The host computer 100 issues a command to instruct the memory 300 to perform a read process, a write process, and the like of data. This host computer 100 includes a processor that executes the process as the host computer 100, and a controller interface for communication with the memory controller 200. The host computer 100 and the memory controller 200 are connected via a signal line 109.

The memory controller 200 controls a request to the memory 300 in accordance with the command from the host computer 100. The memory controller 200 and the memory 300 are connected via a signal line 309.

The memory 300 includes a control section and a memory cell array. This control section of the memory 300 accesses a memory cell in accordance with the request from the memory controller 200. The memory cell array of the memory 300 is a memory cell array having a plurality of memory cells that store any one of binary values for each bit or any one of multiple values for each plurality of bits. A large number of the memory cells are arrayed two-dimensionally (in a matrix) therein. This memory cell array is assumed to be a non-volatile memory (NVM) in which a page having a size of multiple bytes is treated as an access unit for a read or a write and overwriting data without erasure is possible.

### [Memory Controller Configuration]

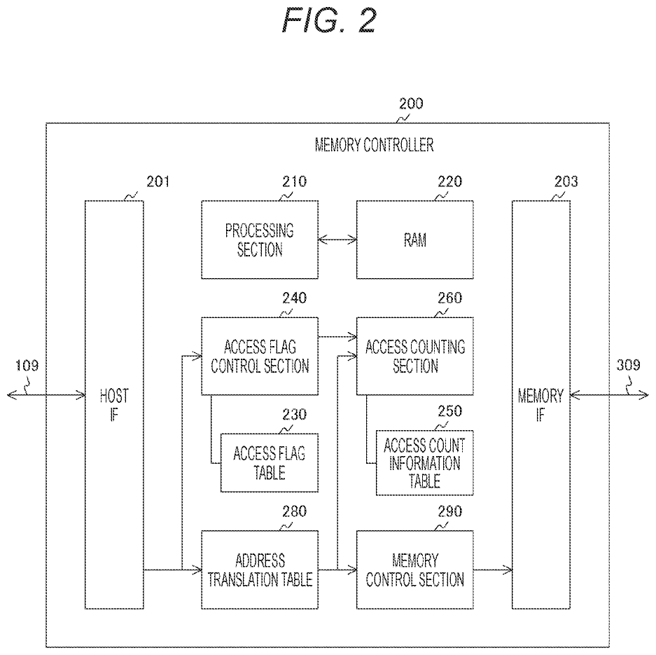

FIG. 2 is a diagram showing a configuration example of a memory controller 200 according to a first embodiment of the present technology.

This memory controller 200 includes a processing section 210, a RAM 220, an access flag table 230, an access flag control section 240, an access count information table 250, an access counting section 260, an address translation table 280, and a memory control section 290. Further, this memory controller 200 includes a host interface 201 for communication with the host computer 100 and a memory interface 203 for communication with the memory 300.

The processing section 210 is a processing section that controls operation of the entire memory controller 200. The RAM 220 is a working memory area that stores a program, data, and the like necessary for operation of the processing section 210.

The access flag table 230 is a table that holds an access flag for each page of the memory 300. The access flag is a flag that holds access history presence/absence for a corresponding page. Note that the access flag table 230 is an example of the access history holding section described in the claims.

The access flag control section 240 updates the access flags in the access flag table 230 in response to an access to the page of the memory 300. Note that the access flag control section 240 is an example of the control section described in the claims.

The access count information table 250 is a table that holds the number of accesses for each page group in which a plurality of pages of the memory 300 is put together. The access counting section 260 counts the number of accesses for each page group of the memory 300, and causes the access count information table 250 to hold it. The access count information table 250 and the access counting section 260 may be realized as a counter that counts the number of accesses for each page group. Note that the access count information table 250 and the access counting section 260 are an example of the access counter described in the claims.

The address translation table 280 translates a logical address included in the command from the host computer 100 into a physical address of the memory 300.

The memory control section 290 controls an access to the memory 300 in accordance with the command from the host computer 100. This memory control section 290 accesses the memory 300 according to the physical address resulting from the translation by the address translation table 280.

### [Address Space]

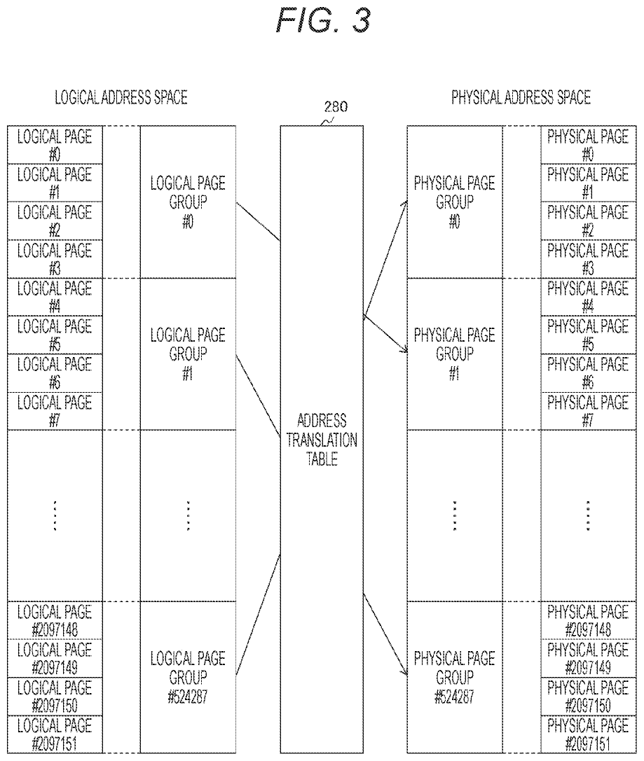

FIG. 3 is a diagram showing a relationship example between a logical address space and a physical address space according to the embodiments of the present technology.

The logical address space is, for example, an 8-Gbyte space, and is divided into 2M (2097152) logical pages assuming that one page is 4 Kbytes. Further, the logical pages are divided into 512K (524288) logical page groups when four pages are managed together as one page group.

The logical address space is allocated to the physical address space of the memory 300. In this example, it is assumed that the physical address space has a size of 8 Gbytes, the same as that of the logical address space, and is divided into 2M (2097152) 4-Kbyte physical pages. Further, the physical pages are divided into 512K (524288) physical page groups when four pages are put together as one page group.

The logical pages in the logical page group can be arranged in the same order as the physical pages. However, the respective page groups may be arranged in a different order.

This corresponding relationship between the logical addresses and the physical addresses is stored in the address translation table 280. According to this address translation table 280, the logical addresses are translated into the physical addresses.

In the memory 300 having such address spaces, an access is executed in page units. Thus, the number of accesses is expected to be counted also in page units. Meanwhile, assuming that a lifespan of the memory is defined as 10⁶ accesses, it is not realistic to provide 2M 20-bit counters. Therefore, if there is provided a counter for each page group in which a plurality of pages is put together, the number of required counters can be significantly reduced although a bit width of the counter is slightly larger.

However, counting all accesses in the page group uniformly may result in a value larger than the number of writes that have actually occurred due to distribution of the accesses to each page. For example, in a case where a specific page has been accessed eight times, the lifespan of that page has been consumed by eight accesses, and it is necessary to grasp the consumption by eight accesses also for the entire page group. On the other hand, in a case where four pages in the page group have each been accessed twice, the lifespan of each page has been consumed by two accesses. However, directly summing up the two accesses to each of the four pages in the page group results in eight accesses, the number of which is different from the proper number of accesses expected to be counted. Thus, in this embodiment, the counter for each page group is provided as the access count information table 250, whereas the access flag holding the access history for each page is provided in the access flag table 230. This allows for counting the number of accesses that matches a degree of the consumption for each page.

Note that, in this embodiment, it is assumed that both the number of reads and the number of writes are counted together as the number of accesses. However, only one of the number of reads and the number of writes, or each of the number of reads and the number of writes may be counted as the number of accesses.

### [Access Flag Table]

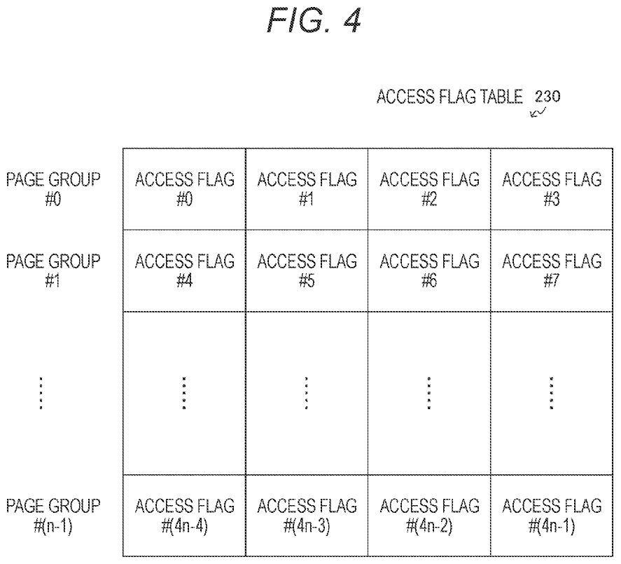

FIG. 4 is a diagram showing an example of the access flag table 230 according to the first embodiment of the present technology.

This access flag table 230 holds an access flag provided for each page. This access flag is a 1-bit flag indicating the access history presence/absence for a corresponding page. For example, this access flag holds “1” if the access history is present, and “0” if the access history is absent.

This access flag table 230 may be managed using the logical page groups or may be managed using the physical page groups.

Note that, this example shows a case where a total of 4n pages are divided into page groups each having four pages, resulting in a total of n page groups.

### [Access Count Information Table]

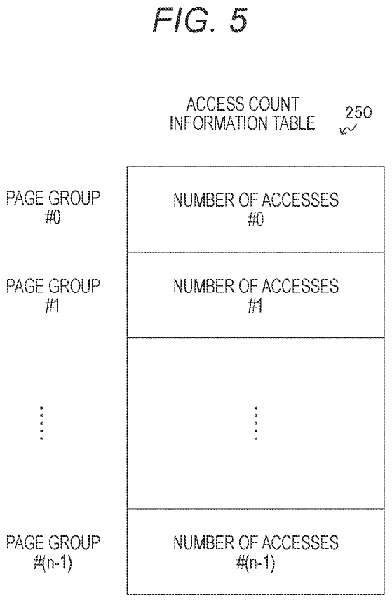

FIG. 5 is a diagram showing an example of the access count information table 250 according to the embodiments of the present technology.

This access count information table 250 holds the number of accesses to the respective pages for each page group. When an access has occurred to a page, the access counting section 260 increments the number of accesses of each page group in the access count information table 250 depending on the state of the access flag for that page in the access flag table 230.

This access count information table 250 is managed using the physical page groups. That is, the number of accesses is managed as a value unique to the physical page group.

### [Operation]

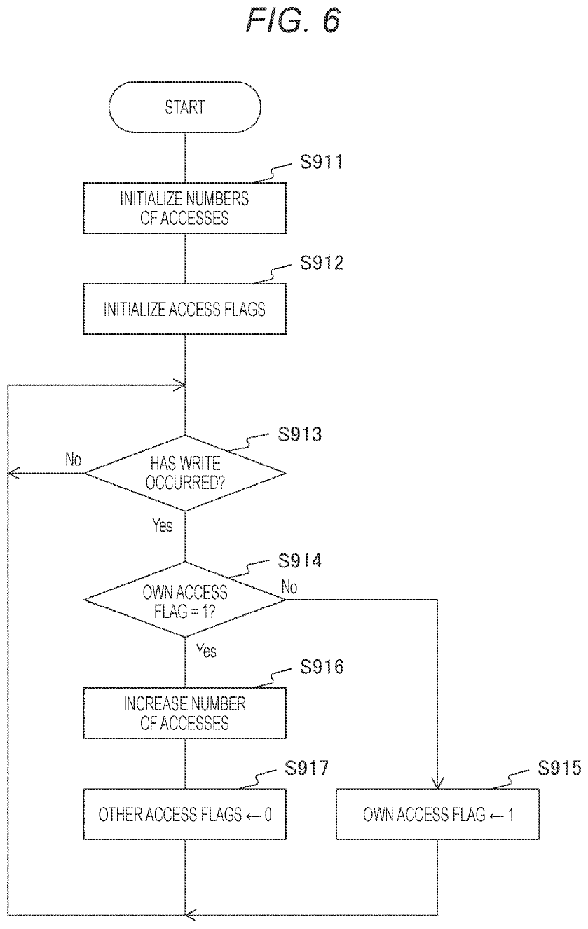

FIG. 6 is a flow chart showing a processing procedure example of an access counting process according to the first embodiment of the present technology.

First, all the numbers of accesses held in the access count information table 250 are initialized to “0” (step S911). Further, all the access flags held in the access flag table 230 are initialized to “1” (step S912).

When an access has occurred to a certain page (step S913: Yes), if the access flag for that page is “0” (step S914: No), that access flag is changed to “1” (step S915).

On the other hand, if the access flag for that page is “1” (step S914: Yes), the number of accesses of the page group to which that page belongs is increased by one (step S916). Then, the access flags for the other pages in the page group to which that page belongs are set to “0” (step S917). Thereafter, a next access is waited for (step S913).

### Specific Example

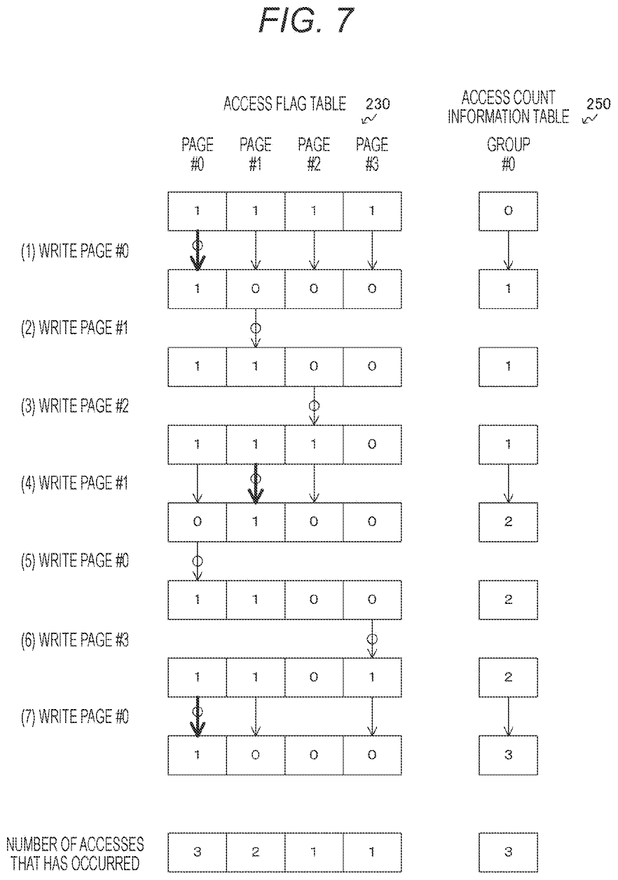

FIG. 7 is a flow chart showing a first specific example of the access counting process according to the first embodiment of the present technology.

In this example, description is given under an assumption that a total of seven accesses have occurred in an order of pages #0, #1, #2, #1, #0, #3, and #0. An initial state of the access count information table 250 is “0”, and an initial state of the access flag table 230 is “1”.

First, when the page #0 is accessed, since the access flag for the page #0 is “1”, the number of accesses of that page group is increased from “0” to “1”. Further, the access flags for the other pages #1 to #3 are changed to “0”.

Next, when the page #1 is accessed, since the access flag for the page #1 is “0”, the access flag for that page #1 is changed to “1”.

Next, when the page #2 is accessed, since the access flag for the page #2 is “0”, the access flag for that page #2 is changed to “1”.

Next, when the page #1 is accessed, since the access flag for the page #1 is “1”, the number of accesses of that page group is increased from “1” to “2”. Further, the access flags for the other pages #0, #2 and #3 are set to “0”.

Next, when the page #0 is accessed, since the access flag for the page #0 is “0”, the access flag for that page #0 is changed to “1”.

Next, when the page #3 is accessed, since the access flag for the page #3 is “0”, the access flag for that page #3 is changed to “1”.

Next, when the page #0 is accessed, since the access flag for the page #0 is “1”, the number of accesses of that page group is increased from “2” to “3”. Further, the access flags for the other pages #1 to #3 are set to “0”.

In these series of processes, the numbers of accesses to the pages #0 to #3 are three, two, one, and one, respectively. Then, the number of accesses held in the access count information table 250 indicates three. That is, this counted number of accesses, three, agrees with the number of accesses of the page #0 indicating the maximum number of accesses. Thus, this example shows that the proper number of accesses expected to be counted is counted correctly.

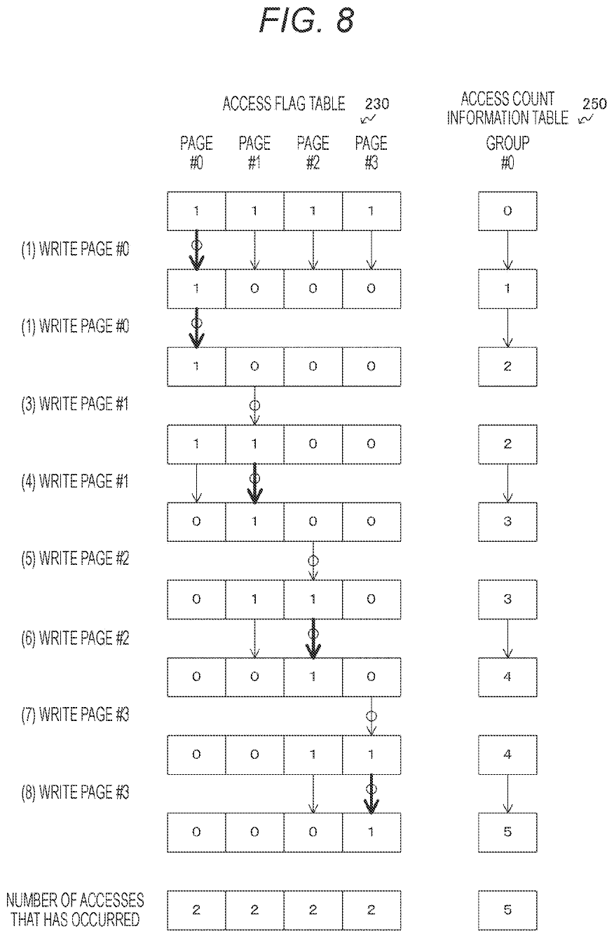

FIG. 8 is a flow chart showing a second specific example of the access counting process according to the first embodiment of the present technology.

In this example, description is given under an assumption that a total of eight accesses have occurred in an order of pages #0, #0, #1, #1, #2, #2, #3, and #3. Note that initial states of the access count information table 250 and the access flag table 230 are similar to those in the first specific example described above.

First, when the page #0 is accessed, since the access flag for the page #0 is “1”, the number of accesses of that page group is increased from “0” to “1”. Further, the access flags for the other pages #1 to #3 are changed to “0”.

Next, when the page #0 is accessed, since the access flag for the page #0 is “1”, the number of accesses of that page group is increased from “1” to “2”. Further, the access flags for the other pages #1 to #3 remain “0”.

Next, when the page #1 is accessed, since the access flag for the page #1 is “0”, the access flag for that page #1 is changed to “1”.

Next, when the page #1 is accessed, since the access flag for the page #1 is “1”, the number of accesses of that page group is increased from “2” to “3”. Further, the access flags for the other pages #0, #2, and #3 are set to “0”.

Next, when the page #2 is accessed, since the access flag for the page #2 is “0”, the access flag for that page #2 is changed to “1”.

Next, when the page #2 is accessed, since the access flag for the page #2 is “1”, the number of accesses of that page group is increased from “3” to “4”. Further, the access flags for the other pages #0, #1, and #3 are set to “0”.

Next, when the page #3 is accessed, since the access flag for the page #3 is “0”, the access flag for that page #3 is changed to “1”.

Next, when the page #3 is accessed, since the access flag for the page #3 is “1”, the number of accesses of that page group is increased from “4” to “5”. Further, the access flags for the other pages #0 to #2 are set to “0”.

In these series of processes, the numbers of accesses to the pages #0 to #3 are each two. On the other hand, the number of accesses held in the access count information table 250 indicates five, and does not agree with any of them. A pattern in which each page is accessed twice in succession as in this example is considered to be the worst case. Assuming that the number of pages in a page group is P, an error of “P−1” from a proper value is observed in this worst case. For example, in the second specific example, “5 accesses” are counted with respect to the proper value “2 accesses”, and the error is “3”. This number agrees with “3” that is the number of pages “4” minus one. In other words, according to this embodiment, the number of accesses can be counted more accurately with the error “P−1” as the worst case.

As described above, in the first embodiment of the present technology, the counter for each page group is provided as the access count information table 250, whereas the access flag holding the access history for each page is provided in the access flag table 230. This allows for counting the number of accesses that matches a degree of the consumption for each page with the suppressed influence of access patterns while reducing the required buffer capacity. Then, using the number of accesses counted in this way allows for appropriately executing the refresh process and the wear leveling process.

### 2. Second Embodiment

In the first embodiment described above, it has been assumed that all the respective access flags for the pages are held in the memory controller 200 as the access flag table 230. However, when a memory space is large, locality of access causes a phenomenon of accessing only some of the pages. Thus, in this second embodiment, it is assumed that an access flag table is stored in the memory 300 and only a necessary portion is held in a memory controller 200.

### [Memory Controller Configuration]

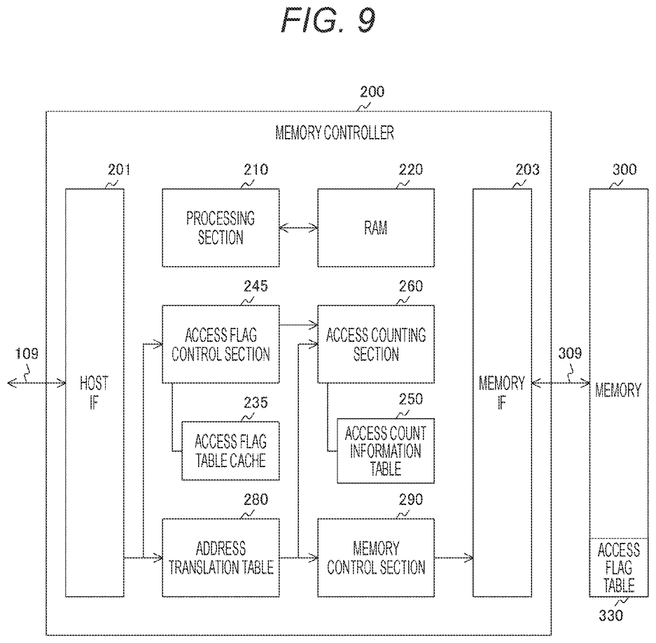

FIG. 9 is a diagram showing a configuration example of a memory controller 200 according to a second embodiment of the present technology.

The memory controller 200 according to this second embodiment holds a portion for frequent access as an access flag table cache 235 instead of the access flag table 230 in the first embodiment described above. This allows for reducing a storage area for the access flags in the memory controller 200. In this second embodiment, an access flag table 330 as a main body is held in the memory 300. Note that the access flag table cache 235 is an example of the access history holding section described in the claims.

Further, the memory controller 200 according to this second embodiment includes an access flag control section 245 instead of the access flag control section 240 in the first embodiment described above. This access flag control section 245 controls updating of the access flags in the access flag table cache 235 in response to an access to the page. Further, this access flag control section 245 controls replacement between the access flag table 330 in the memory 300 and the access flag table cache 235.

Note that an access count information table 250 in this second embodiment has a configuration similar to that in the first embodiment described above, and holds the number of accesses to the respective pages for each page group for the entire memory 300.

### [Access Flag Table Cache]

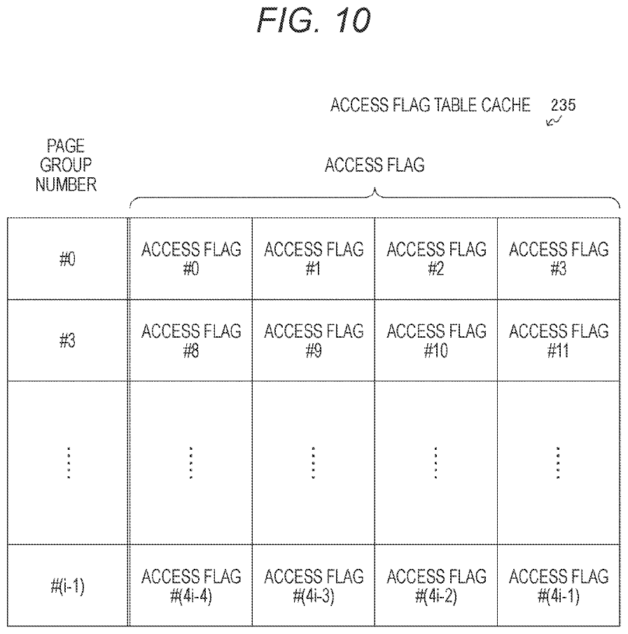

FIG. 10 is a diagram showing an example of the access flag table cache 235 according to the second embodiment of the present technology.

This access flag table cache 235 holds only some of the page groups of the access flag table 330 provided for each page. Thus, this access flag table cache 235 stores a page group number for each of the page groups. This allows for determining which page group the access flag corresponds to.

In a case where an access has occurred to the page group held in this access flag table cache 235, the number of accesses of that page group is incremented by one in accordance with a rule similar to that in the first embodiment described above.

In a case where an access has occurred to the page group not held in this access flag table cache 235, the access flags corresponding to that page group are newly registered in a free area of the access flag table cache 235. At this time, the newly registered access flags are in the initial state.

However, in a case where there is no free area in the access flag table cache 235, the access flags for any page group are deregistered before the new registration. In this case, for example, a method by the least recently used (LRU) algorithm of deregistering the access flags that have not been used for the longest time, and the like can be used. Further, when the access flags are deregistered, half of the normal addition value can be added since the deregistration is performed before an access occurs. This allows the number of accesses to increase even if registration and deregistration are repeatedly performed.

### Specific Example

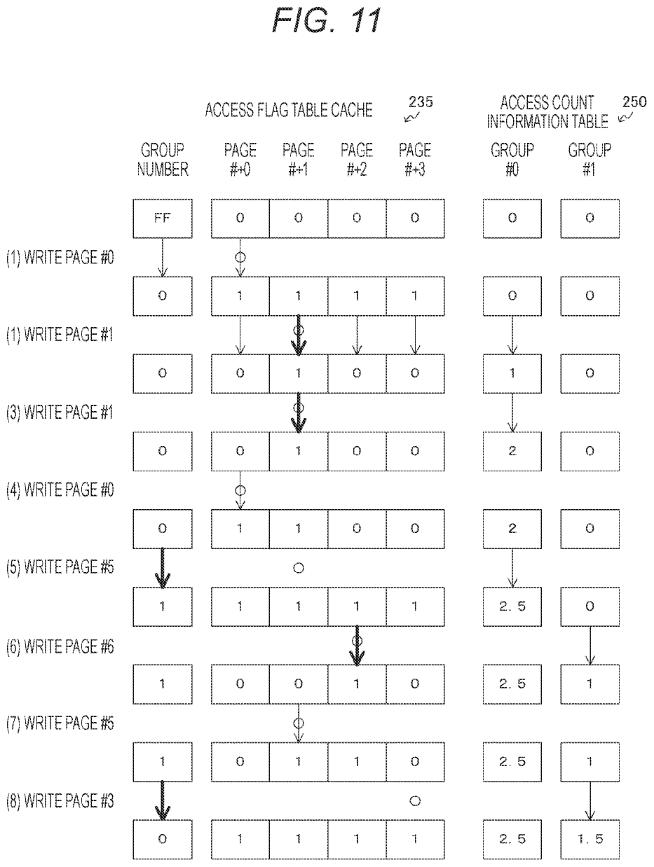

FIG. 11 is a flow chart showing a specific example of an access counting process according to the second embodiment of the present technology.

In this example, description is given under an assumption that a total of eight accesses have occurred in an order of pages #0, #1, #1, #0, #5, #6, #5, and #3. The initial state of the access count information table 250 is “0”. Further, the access flag table cache 235 is assumed to hold only access flags for one page group for convenience of explanation, and the initial state of the access flags at a time of new registration is “1”.

First, when the page #0 is accessed, the access flags for a page group #0 are newly registered in the access flag table cache 235, and the page group number is set to “0”. Further, the access flags are set to the initial state “1”.

Next, when the page #1 is accessed, since the access flag for the page #1 is “1”, the number of accesses of that page group is increased from “0” to “1”. Further, the access flags for the other pages #0, #2, and #3 are changed to “0”.

Next, when the page #1 is accessed again, since the access flag for the page #1 is “1”, the number of accesses of that page group is increased from “1” to “2”. Further, the access flags for the other pages #0, #2, and #3 remain “0”.

Next, when the page #0 is accessed, since the access flag for the page #0 is “0”, the access flag for that page #0 is changed to “1”.

Next, when the page #5 is accessed, the access flags for the page group “0” are deregistered, and the access flags for a page group number “1” are newly registered. At that time, the number of accesses for the page group “0” is incremented by “0.5” to be “2.5”. Then, the page group number of the access flag table cache 235 is set to “1”. Further, the access flags are set to the initial state “1”.

Next, when the page #6 is accessed, since the access flag for the page #6 is “1”, the number of accesses of that page group is increased from “0” to “1”. Further, the access flags for the other pages #4, #5, and #7 are changed to “0”.

Next, when the page #5 is accessed, since the access flag for the page #5 is “0”, the access flag for that page #5 is changed to “1”.

Next, when the page #3 is accessed, the access flags for the page group “1” are deregistered, and the access flags for a page group number “0” are newly registered. At that time, the number of accesses of the page group “1” is incremented by “0.5” to be “1.5”. Then, the page group number of the access flag table cache 235 is set to “0”. Further, the access flags are set to the initial state “1”.

In these series of processes, the maximum number of accesses of the page group “0” is two for the page #1, and the maximum number of accesses of the page group “1” is two for the page #5. Then, the numbers of accesses held in the access count information table 250 indicate 2.5 for the page group “0” and 1.5 for the page group “1”. Thus, this example shows that the proper numbers of accesses expected to be counted are counted almost correctly.

As described above, according to the second embodiment of the present technology, the storage area in the memory controller 200 can be reduced by the access flag table cache 235 holding the access flags for the page group frequently accessed.

Note that the above-described embodiments show examples for embodying the present technology, and matters in the embodiments and matters specifying the invention in the claims have a corresponding relationship with each other. Similarly, the matters specifying the invention in the claims and the matters in the embodiments of the present technology denoted by the same names have a corresponding relationship with each other. However, the present technology is not limited to the embodiments, and can be embodied by applying various modifications to the embodiments without departing from the spirit of the present technology.

Further, the processing procedure described in the above-described embodiments may be regarded as a method having this sequential procedure, or as a program for causing a computer to execute this sequential procedure and a recording medium storing that program. As this recording medium, for example, a compact disc (CD), a MiniDisc (MD), a digital versatile disc (DVD), a memory card, a Blu-ray (registered trademark) disc, and the like can be used.

Note that the effects described in the present specification are merely examples and are not limited, and further, other effects may be provided.

Additionally, the present technology can also be configured as below.

(1) An access counting device including:

an access history holding section that holds an access history for each of first storage units of a memory;

an access counter provided for each of second storage units corresponding to a set of a plurality of the first storage units, the access counter being configured to count a number of accesses; and

a control section configured to update the access history in the access history holding section in response to an access to the first storage unit of the memory and to increment the number of accesses of the second storage unit in the access counter depending on a state of the access history.

(2) The access counting device according to (1) described above,

in which the access history holding section holds as the access history a flag of one bit indicating either a first value indicating access history presence or a second value indicating access history absence for each of the first storage units.

(3) The access counting device according to (2) described above,

in which the control section is configured to, when an access to the first storage unit of the memory has occurred, in a case where the flag for the first storage unit to which that access has occurred indicates the first value, update the flag for another first storage unit in the second storage unit to which the access has occurred to the second value and increment the number of accesses of the second storage unit in the access counter, and, in a case where the flag for the first storage unit to which the access has occurred indicates the second value, update the flag for the first storage unit to which the access has occurred to the first value.

(4) The access counting device according to any one of (1) to (3) described above,

in which the access history holding section holds the access history for each of the first storage units using a physical address of the memory, and

the access counter is configured to count the number of accesses for each of the second storage units using the physical address of the memory.

(5) The access counting device according to any one of (1) to (3) described above, further including

an address translation section configured to translate a logical address to the physical address of the memory when an access destination with respect to the memory is specified by that logical address,

in which the access history holding section holds the access history for each of the first storage units using the logical address of the memory, and

the access counter is configured to count the number of accesses for each of the second storage units using the physical address of the memory.

(6) The access counting device according to any one of (1) to (5) described above,

in which the access history holding section holds the access history for each of the first storage units for at least one of the second storage units of the memory, and

in a case where an access to the second storage unit that is not held in the access history holding section has occurred, the control section newly holds the access history for each of the first storage units for that second storage unit.

(7) The access counting device according to (6) described above,

in which the control section is configured to, in a case where there is no free area for newly holding the access history for each of the first storage units for the second storage unit, delete the access histories for the second storage unit already held in accordance with a predetermined rule and increment the number of accesses of the deleted second storage unit in the access counter by less than usual.

(8) The access counting device according to any one of (1) to (7) described above,

in which the access counter is configured to count a number of writes as the number of accesses.

(9) The access counting device according to any one of (1) to (7) described above,

in which the access counter is configured to count both a number of writes and a number of reads as the number of accesses.

(10) A memory controller including:

an access history holding section that holds an access history for each of first storage units of a memory regarding an access from a host computer to the memory;

an access counter provided for each of second storage units corresponding to a set of a plurality of the first storage units, the access counter being configured to count a number of accesses; and

a control section configured to update the access history in the access history holding section in response to an access to the first storage unit of the memory and to increment the number of accesses of the second storage unit in the access counter depending on a state of the access history.

(11) A memory system including:

a memory;

an access history holding section that holds an access history for each of first storage units of the memory regarding an access from a host computer to the memory;

an access counter provided for each of second storage units corresponding to a set of a plurality of the first storage units, the access counter being configured to count a number of accesses; and

a control section configured to update the access history in the access history holding section in response to an access to the first storage unit of the memory and to increment the number of accesses of the second storage unit in the access counter depending on a state of the access history.

### REFERENCE SIGNS LIST

100 Host computer
200 Memory controller
201 Host interface
203 Memory interface
210 Processing section
220 RAM
230, 330 Access flag table
235 Access flag table cache
240, 245 Access flag control section
250 Access count information table
260 Access counting section
280 Address translation table
290 Memory control section
300 Memory
400 Memory system

1. An access counting device comprising:
an access history holding section that holds an access history for each of first storage units of a memory;
an access counter provided for each of second storage units corresponding to a set of a plurality of the first storage units, the access counter being configured to count a number of accesses; and
a control section configured to update the access history in the access history holding section in response to an access to the first storage unit of the memory and to increment the number of accesses of the second storage unit in the access counter depending on a state of the access history.

2. The access counting device according to claim 1,
wherein the access history holding section holds as the access history a flag of one bit indicating either a first value indicating access history presence or a second value indicating access history absence for each of the first storage units.

3. The access counting device according to claim 2,
wherein the control section is configured to, when an access to the first storage unit of the memory has occurred, in a case where the flag for the first storage unit to which that access has occurred indicates the first value, update the flag for another first storage unit in the second storage unit to which the access has occurred to the second value and increment the number of accesses of the second storage unit in the access counter, and, in a case where the flag for the first storage unit to which the access has occurred indicates the second value, update the flag for the first storage unit to which the access has occurred to the first value.

4. The access counting device according to claim 1,
wherein the access history holding section holds the access history for each of the first storage units using a physical address of the memory, and
the access counter is configured to count the number of accesses for each of the second storage units using the physical address of the memory.

5. The access counting device according to claim 1, further comprising
an address translation section configured to translate a logical address to the physical address of the memory when an access destination with respect to the memory is specified by that logical address,
wherein the access history holding section holds the access history for each of the first storage units using the logical address of the memory, and
the access counter is configured to count the number of accesses for each of the second storage units using the physical address of the memory.

6. The access counting device according to claim 1,
wherein the access history holding section holds the access history for each of the first storage units for at least one of the second storage units of the memory, and
in a case where an access to the second storage unit that is not held in the access history holding section has occurred, the control section newly holds the access history for each of the first storage units for that second storage unit.

7. The access counting device according to claim 6,
wherein the control section is configured to, in a case where there is no free area for newly holding the access history for each of the first storage units for the second storage unit, delete the access histories for the second storage unit already held in accordance with a predetermined rule and increment the number of accesses of the deleted second storage unit in the access counter by less than usual.

8. The access counting device according to claim 1,
wherein the access counter is configured to count a number of writes as the number of accesses.

9. The access counting device according to claim 1,
wherein the access counter is configured to count both a number of writes and a number of reads as the number of accesses.

10. A memory controller comprising:
an access history holding section that holds an access history for each of first storage units of a memory regarding an access from a host computer to the memory;
an access counter provided for each of second storage units corresponding to a set of a plurality of the first storage units, the access counter being configured to count a number of accesses; and
a control section configured to update the access history in the access history holding section in response to an access to the first storage unit of the memory and to increment the number of accesses of the second storage unit in the access counter depending on a state of the access history.

11. A memory system comprising:
a memory;
an access history holding section that holds an access history for each of first storage units of the memory regarding an access from a host computer to the memory;
an access counter provided for each of second storage units corresponding to a set of a plurality of the first storage units, the access counter being configured to count a number of accesses; and
a control section configured to update the access history in the access history holding section in response to an access to the first storage unit of the memory and to increment the number of accesses of the second storage unit in the access counter depending on a state of the access history.
